(19) United States
(12) Patent Application Publication
(10) Pub. No.: US 2025/0271559 A1
(43) Pub. Date: Aug. 28, 2025

(54) LASER RADAR

(71) Applicant: BEIJING MORELITE SEMICONDUCTOR CO., LTD., Beijing (CN)

(72) Inventors: Guomin JIANG, Beijing (CN); Yunsong WANG, Beijing (CN); Jie SUN, Beijing (CN); Tianbo SUN, Beijing (CN)

(21) Appl. No.: 19/207,024

(22) Filed: May 13, 2025

Related U.S. Application Data
(63) Continuation of application No. PCT/CN2023/131668, filed on Nov. 15, 2023.

(30) Foreign Application Priority Data
Nov. 18, 2022 (CN) 202211448601.X

(51) Int. Cl. G01S 7/4912; G01S 7/481; G01S 7/4914; G01S 7/499; G01S 17/34; G01S 17/58

(52) U.S. Cl. CPC G01S 7/4917; G01S 7/4811; G01S 7/4817; G01S 7/4914; G01S 7/499; G01S 17/34; G01S 17/58

(57) ABSTRACT

A laser radar is provided. The LiDAR system comprises: a LiDAR chip comprising at least one laser transmission-detection channel, each of which includes a primary transmission-detection channel and a secondary detection channel, wherein the primary transmission-detection channel is configured to transmit a detection light beam and have a light transmitting/receiving end configured to emit the detection light beam, the detection light beam is separately reflected after encountering an obstacle to generate a reflected light beam, and the light transmitting/receiving end further receives a first part of the reflected light beam; the secondary detection channel has a light receiving end which receives a second part of the reflected light beam, and the LiDAR system measures the distance and/or speed of the obstacle according to the first part and the second part of the reflected light beam.

### CROSS-REFERENCE TO RELATED APPLICATION

This application is a continuation of a PCT application No. PCT/CN2023/131668 filed on Nov. 15, 2023, which claims priority to Chinese Patent Application No. 202211448601.X filed on Nov. 18, 2022 in China, the disclosure of which is hereby incorporated by reference in its entirety.

### TECHNICAL FIELD

The present disclosure relates to the technical field of Light Detection And Ranging (LiDAR), and in particular, to a LiDAR system.

### BACKGROUND

A LiDAR system is a radar system that emits laser beam to detect a characteristic metric such as a position and a velocity of a target. The working principle of the LiDAR system is to transmit a detection signal to a target, then compare a received signal reflected back from the target with a transmitted signal, and after appropriate processing, obtain related information of the target, such as parameters such as a target distance, an orientation, a height, a speed, an altitude, or even a shape, so as to detect, track and identify targets such as an aircraft and a missile. The LiDAR system are now widely deployed in different scenarios, such as in automated vehicles. The LiDAR system may actively estimate the distance and the speed of an environmental feature when scanning the environmental feature, and generate a point location cloud indicating a three-dimensional shape of the environmental feature. The LiDAR system is one of core sensors widely used in autonomous driving scenarios, and may be used to collect three-dimensional information of an external environment. According to a detection mechanism, the LiDAR system may be mainly divided into two LiDAR systems of Time of Flight (Time of Flight) and Frequency Modulated Continuous Wave (FMCW).

### SUMMARY

A Light Detection And Ranging (LiDAR) system is provided in the embodiments of the present disclosure. The system includes: a LiDAR chip, including at least one laser transmission-detection channel, wherein each of the at least one laser transmission-detection channel includes: a primary transmission-detection channel configured to transmit a detection light beam, wherein the primary transmission-detection channel has a light transmitting/receiving end, the light transmitting/receiving end is configured to emit a detection light beam, the detection light beam is reflected to generate a reflected light beam after encountering an obstacle, and the light transmitting/receiving end is further configured to receive a first part of the reflected light beam; and a secondary detection channel, wherein the secondary detection channel has a light receiving end, and the light receiving end is configured to receive a second part of the reflected light beam, wherein the LiDAR system measures a distance and/or a speed of the obstacle according to the first part and the second part of the reflected light beam.

In some embodiments, the LiDAR chip further includes: a receiving port configured to receive a laser; and an optical splitter configured to split the laser into a detection laser and a local oscillation laser, wherein the detection laser and the local oscillation laser are configured to be transmitted to the laser transmission-detection channel.

In some embodiments, the primary transmission-detection channel includes: a first mixer configured to receive at least a part of the local oscillation laser and a first part of the reflected light beam, and perform a frequency-mixing operation on at least the part of the local oscillation laser and the first part of the reflected light beam to obtain a first mixed beam; and a first detector configured to receive the first mixed beam and detect a first beat frequency between at least the part of the local oscillation laser and the first part of the reflected light beam. The secondary detection channel includes: a second mixer configured to receive at least a part of the local oscillation laser and a second part of the reflected light beam, and perform a frequency-mixing operation on at least the part of the local oscillation laser and the second part of the reflected light beam to obtain a second mixed beam; and a second detector configured to receive the second mixed beam and detect a second beat frequency between at least the part of the local oscillation laser and the second part of the reflected light beam.

In some embodiments, the LiDAR system further includes: a processor, configured to determine a measurement result of the obstacle based on the first beat frequency and the second beat frequency.

In some embodiments, the LiDAR system further includes: a lens assembly configured to collimate and deflect the detection light beam emitted by the light emitting/receiving end, and perform focusing on the reflected light beam to be coupled into the light transmitting/receiving end or the light receiving end; and a beam-scanning guide apparatus, on a side of the lens assembly close to the obstacle and configured to adjust an emission direction of the detection light beam emitted from the light emitting/receiving end over time to implement beam scanning.

In some embodiments, the detection light beam is TE-mode polarized light, the reflected light beam includes TE-mode polarized light and TM-mode polarized light, and the LiDAR system further includes: a polarization beam-splitting apparatus arranged between the LiDAR chip and the lens assembly, wherein the polarization beam-splitting apparatus is configured to allow the TM-mode polarized light in the reflected light beam to pass in an original direction so that the TM-mode polarized light in the reflected light beam is incident to the light transmitting/receiving end; and is configured to translate and bias the TE-mode polarized light in the reflected light beam so that the TE-mode polarized light in the reflected light beam to be incident to the light receiving end.

In some embodiments, the polarization beam-splitting apparatus includes a Faraday rotator, a half-wave plate and a polarization beam bias device sequentially arranged away from the LiDAR chip, the detection light beam sequentially passes through the Faraday rotator and the half-wave plate and then is converted into the TM-mode polarized light from the TE-mode polarized light, the TM-mode polarized light passes through the lens assembly and the beam-scanning guide apparatus after passing through the polarization beam bias device in an original direction, and reaches the obstacle to generate the reflected light beam, the reflected light beam is returned to the polarization beam bias device along the original light path, the TM-mode polarized light in the reflected light beam passes through the half-wave plate and the Faraday rotator in sequence after passing through the polarization beam bias device with the original direction unchanged, and then is incident onto the light transmitting/receiving end; the TE-mode polarized light in the reflected light beam passes through the half-wave plate and the Faraday rotator in sequence after being translated and biased by the polarization beam bias device, and then is incident to the light receiving end.

In some embodiments, a distance between the light emitting/receiving end and the light receiving end is substantially equal to a bias distance d of the polarization beam bias device to the TE-mode polarized light in the reflected light beam, and the bias distance d satisfies the following formula:

$$tan ( α ) = ( 1 - \frac{{n}_{o}^{2}}{{n}_{e}^{2}} ) \cdot \frac{tan ( θ )}{1 + \frac{{n}_{o}^{2}}{{n}_{e}^{2}} \cdot {tan}^{2} ( θ )}$$

$$d = L \times tan ( α )$$

wherein L is a thickness of the polarization beam bias device, α is a bias angle of the polarization beam bias device to the TE-mode polarized light, θ is an angle between an optical axis of the polarization beam bias device and a wave vector, nₒ is a refractive index of the TM-mode polarized light in the polarization beam bias device, and nₑ is a refractive index of the TE-mode polarized light in the polarization beam bias device.

In some embodiments, the primary transmission-detection channel has a polarization rotator configured to convert the received TM-mode polarized light into TE-mode polarized light.

In some embodiments, the LiDAR system further includes: a laser source docked with the LiDAR chip and configured to generate a laser.

Compared with the related art, the above solutions of the embodiments of the present disclosure have at least the following beneficial effects: the LiDAR system receives the first part of the reflected light beam through the light emitting/receiving end of the primary transmission-detection channel, receives the second part of the reflected light beam through the light receiving end of the secondary detection channel, fully utilizes the reflected light beam to determine the obstacle, and improves the measurement precision. Meanwhile, the situation that the object cannot be detected due to the fact that the TM-mode polarized light in the reflected light beam of the object is weak and the TE-mode polarized light is strong is avoided. The intensity ratio of the TE-mode polarized light in the reflected light beam to the TM-mode polarized light can be obtained by comparing the intensities of the energy detected by the two detection channels, so as to determine the reflection characteristic and the surface topography of the object.

### BRIEF DESCRIPTION OF THE DRAWINGS

The accompanying drawings, which are incorporated in and constitute a part of this specification, illustrate embodiments consistent with the present disclosure and, together with the description, serve to explain the principles of the present disclosure. Obviously, the accompanying drawings in the following description are merely some embodiments of the present disclosure, and for a person of ordinary skill in the art, other drawings may be obtained according to these drawings without creative efforts. In the drawings:

FIG. 1 is a schematic structural diagram of a LiDAR system according to some embodiments of the present disclosure;

FIG. 2 is a schematic diagram of a partial structure of a LiDAR chip according to some embodiments of the present disclosure;

FIG. 3 is a waveform diagram of an emitted light beam and a received light beam in an FWCW frequency-sweeping manner provided by the present disclosure.

### DETAILED DESCRIPTION

In order to make the objectives, technical solutions, and advantages of the present disclosure clearer, the present disclosure will be further described in detail below with reference to the accompanying drawings. All other embodiments obtained by a person of ordinary skill in the art based on the embodiments of the present disclosure without creative efforts shall fall within the protection scope of the present disclosure.

The terms used in the embodiments of the present disclosure are merely for the purpose of describing particular embodiments, and are not intended to limit the present disclosure. As used in the embodiments of the present disclosure and the appended claims, the singular forms “a”, “the” and “the” are also intended to include plural forms, unless the context clearly indicates other meanings, “a plurality of” generally includes at least two.

It should be understood that the term “and/or” used in this specification is merely an association relationship for describing associated objects, indicating that there may be three relationships, for example, A and/or B may indicate that A exists alone, A and B exist at the same time, and B exists alone. In addition, the character “/” in this specification generally indicates an “or” relationship between the associated objects.

It should be understood that although the terms first, second, third, etc. may be used in the embodiments of the present disclosure to describe, these should not be limited to these terms. These terms are only used to distinguish similar objects apart. For example, first may also be referred to as second, and similarly, second may also be referred to as first without departing from the scope of the embodiments of the present disclosure.

It should also be noted that the terms “comprising,” “including,” or any other variation thereof are intended to cover a non-exclusive inclusion, so that a commodity or apparatus including a series of elements not only includes those elements, but also includes other elements that are not explicitly listed, or further includes elements inherent to the commodity or apparatus. In the absence of more restrictions, an element defined by the sentence “including a” does not exclude that there are additional identical elements in the commodity or apparatus that includes the element.

In the art, the LiDAR system mainly includes the following two technical routes: Time of Flight (TOF) and Frequency-Modulated Continuous Wave (FMCW). The principle of distance measurement of TOF is that the distance is measured by multiplying the time of flight of a light pulse between the target object and the LiDAR system by the speed of light, and the LiDAR system in ToF adopts a pulse amplitude modulation technology. Different from the ToF route, FMCW mainly enables the return light with the local-oscillation light by sending and receiving a continuous laser beam, measures the frequency difference between sending and receiving by using a frequency-mixing detection technology, and then calculates the distance of the target object by using the frequency difference. In short, TOF uses time of flight to measure distance, while FMCW uses frequency to measure a distance. Compared with ToF, FMCW has the following advantages: an optical wave of ToF is easily interfered by the ambient light, and the anti-interference capability of FMCW is strong; the signal-to-noise ratio of ToF is too low, the signal-to-noise ratio of FMCW is very high, the quality of data in a speed dimension of ToF is low, and FMCW can obtain the data of each pixel in the speed dimension.

In the related art, in the LiDAR system of FMCW, in order to miniaturize the light emitting end and the light receiving end as an integrated structure, the detection light beam emitted by the LiDAR system is usually TE-mode polarized light, the TE-mode polarized light is transmitted in a single mode waveguide in the chip, the TE-mode polarized light generates a reflected light beam when encountering an obstacle, and the reflected light beam usually does not have a specific polarization characteristic, for example, is natural light, and it may be considered that the reflected light beam includes TE-mode polarized light and TM-mode polarized light. Generally, only TM-mode polarized light in the reflected light beam is received by the integrated transmitting/receiving end for performing obstacle determination. The reason is that the TE-mode polarized light is returned along the original transmission path in the transmission-detection channel in the LiDAR chip after being received by the integrated transmitting/receiving end, and cannot enter the detection path in the transmission-detection channel, and cannot be effectively utilized. Therefore, the FMCW LiDAR system in the related art needs a sufficiently strong detection beam to obtain the effectively used TM-mode polarized light in a sufficiently strong reflected light beam, which requires a high-power LiDAR system. When the power of the LiDAR system is too small, the effectively used TM-mode polarized light in the reflected light beam is weak, which may lead to inaccurate determination of the LiDAR system.

The present disclosure provides a LiDAR system, which includes: a LiDAR chip including at least one laser transmission-detection channel, and the laser transmission-detection channel includes a primary transmission-detection channel and a secondary detection channel, wherein the primary transmission-detection channel is configured to transmit a detection light beam, the primary transmission-detection channel has a light transmitting/receiving end, the light transmitting/receiving end is configured to emit a detection light beam, the detection light beam is reflected by an obstacle to generate a reflected light beam, and the light transmitting/receiving end is further configured to receive a first part of the reflected light beam; the secondary detection channel has a light receiving end configured to receive a second part of the reflected light beam, wherein the LiDAR system measures the obstacle according to the first part and the second part of the reflected light beam.

The LiDAR system receives the first part of the reflected light beam through the light emitting/receiving end of the primary transmission-detection channel, receives the second part of the reflected light beam through the light receiving end of the secondary detection channel, fully utilizes the reflected light beam to determine the obstacle, and improves the measurement precision. Meanwhile, the situation that the obstacle cannot be detected due to the fact that the TM-mode polarized light is weak in the reflected light beam from the object and the TE-mode polarized light is high is avoided. The intensity ratio of the TE-mode polarized light to the TM-mode polarized light in the reflected light beam can be obtained by comparing the intensities of the energy detected by the two detection channels, so as to determine the reflection characteristic and the surface topography of the obstacle.

Optional embodiments of the present disclosure are described in detail below with reference to the accompanying drawings.

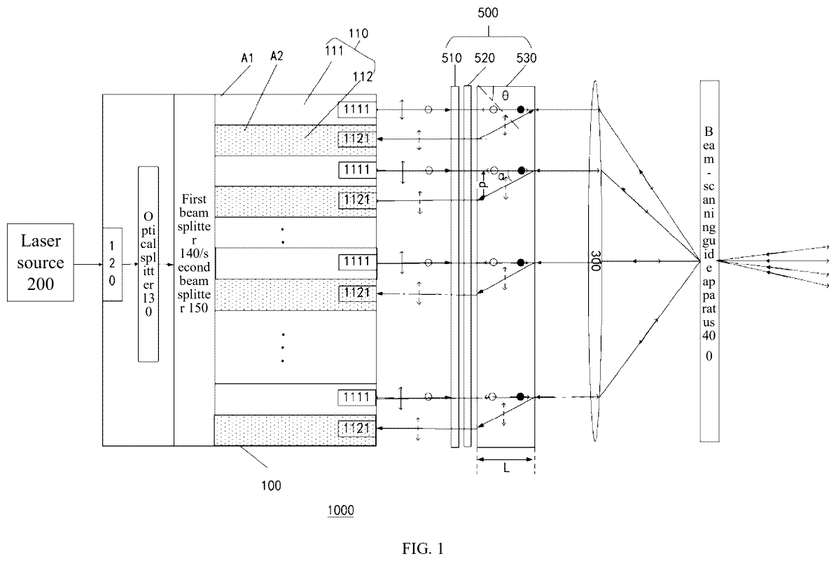

FIG. 1 is a schematic structural diagram of a LiDAR system according to some embodiments of the present disclosure. As shown in FIG. 1, the present disclosure provides a LiDAR system 1000, including a LiDAR chip 100, which is an FMCW LiDAR chip.

The LiDAR chip 100 includes a substrate and at least one laser transmission-detection channel 110 disposed on the substrate, and the substrate is, for example, a silicon-based substrate. For example, the number of the laser transmission-detection channels 110 is N, N is a positive integer greater than or equal to 1, and the N laser transmission-detection channels 110 are sequentially arranged on the substrate in parallel. The N laser transmission-detection channels 110 are respectively used for transmitting N detection beams, the N detection beams are respectively reflected after encountering an obstacle to generate N reflected light beams, and the N laser transmission-detection channels 110 are further configured to respectively receive at least a part of each of the N reflected light beams for performing measurement of each channel.

The N laser transmission-detection channels 110 may separately measure N points on the corresponding obstacle, for example, measure parameters such as the distance and speed of each point, where the distance refers to the distance between the position of the point and the LiDAR system, and the speed here refers to the speed of the point relative to the LiDAR system. Further, parameters such as distance, speed, and morphology of the entirety of the obstacle are determined.

Each laser transmission-detection channel 110 has the same working principle, which is specifically described below by taking a laser transmission-detection channel 110 as an example.

The laser transmission-detection channel 110 includes a primary transmission-detection channel 111 and a secondary detection channel 112.

The primary transmission-detection channel 111 is configured to transmit a detection light beam, the primary transmission-detection channel 111 has a light emitting/receiving end 1111, the light emitting/receiving end 1111 is configured to emit a detection light beam, the detection light beam is respectively reflected to generate a reflected light beam after encountering an obstacle, and the light emitting/receiving end 1111 is further configured to receive a first part of the reflected light beam, for example, a TM-mode polarized light in the reflected light beam. The secondary detection channel 112 has a light receiving end 1121, and the light receiving end 1121 is configured to receive a second part of the reflected light beam, for example, a TE-mode polarized light in a reflected light beam, and the LiDAR system 1000 measures the distance and/or the speed of the obstacle according to the first part and the second part of the reflected light beam.

Compared with the related art in which only the TM-mode polarized light in the reflected light beam is used to perform detection, the embodiments of the present disclosure simultaneously use the TM-mode polarized light and the TE-mode polarized light in the reflected light beam to perform detection, which increases the proportion of the reflected light beam used for receiving and executing the detection, and can improve the measurement precision of the LiDAR system. Meanwhile, the situation that the obstacle cannot be detected due to the fact that the TM-mode polarized light in the reflected light beam of the object is weak and the TE-mode polarized light is high is avoided. The intensity ratio of the TE-mode polarized light in the reflected light beam to the TM-mode polarized light can be obtained by comparing the intensities of the energy detected by the two detection channels, so as to determine the reflection characteristic and the surface topography of the object.

In some embodiments, as shown in FIG. 1, the LiDAR chip 100 further includes a receiving port 120 and an optical splitter 130, the receiving port 120 is configured to receive a laser, and the detection laser is input into the LiDAR chip 100 from, for example, the environment. The optical splitter 130 is configured to split the laser into a detection laser and a local oscillation laser, and the detection laser and the local oscillation laser are configured to be transmitted to the laser transmission-detection channel 110 and the detection laser and the local oscillation laser have the same frequency at any time instant, that is, the frequency modulation waveforms of the detection laser and the local oscillation laser are completely the same.

In some embodiments, the LiDAR chip 100 further includes a first beam splitter 140 and a second beam splitter 150, the first beam splitter 140 is disposed between the optical splitter 130 and the N laser transmission-detection channels 110, and is configured to split the detection laser into the N detection beams, and transmit the N detection beams to the N laser transmission-detection channels 110 respectively, and the second beam splitter 150 is disposed between the optical splitter 130 and the N laser transmission-detection channels 110, and is configured to split the local oscillation laser into 2N local oscillation beams, and each laser transmission-detection channel receives two local oscillation beams. The two local oscillation beams are respectively received by the primary transmission-detection channel and the secondary detection channel of the laser transmission-detection channel for performing the measurement operation.

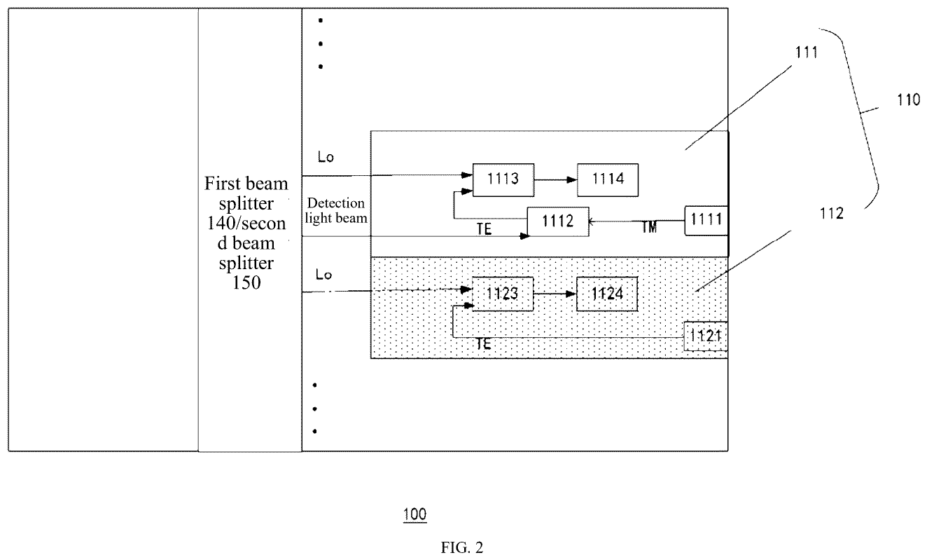

FIG. 2 is a schematic diagram of a partial structure of a LiDAR chip according to some embodiments of the present disclosure, and shows a specific structure of a laser transmission-detection channel 110. As shown in FIG. 1 and FIG. 2, the primary transmission-detection channel 111 includes a first mixer 1113 and a first detector 1114, the first mixer 1113 is configured to receive at least a part of the local oscillation laser and a first part of the reflected light beam, and perform a frequency-mixing operation on at least a part of the local oscillation laser and a first part of the reflected light beam to obtain a first mixed beam. The first detector 1114 is configured to receive the first mixed beam and detect a first beat frequency between at least a part of the local oscillation laser and a first portion of the reflected light beam. At least a part of the local oscillation laser is, for example, a local oscillation sub-beam Lo, and a first part of the reflected light beam is, for example, TM-mode polarized light in the reflected light beam.

The secondary detection channel 112 includes a second mixer 1123 and a second detector 1124, wherein the second mixer 1123 is configured to receive at least a part of the local oscillation laser and a second part of the reflected light beam, and perform a frequency-mixing operation on at least a part of the local oscillation laser and a second part of the reflected light beam to obtain a second mixed beam. The second detector 1124 is configured to receive the second mixed beam and detect a second beat frequency between at least a part of the local oscillation laser and a second portion of the reflected light beam. At least a part of the local oscillation laser is, for example, a local oscillation sub-beam Lo, and a second part of the reflected light beam is, for example, TE-mode polarized light in the reflected light beam.

That is, the primary transmission-detection channel 111 performs detection by using the TM-mode polarized light in the reflected light beam, and the secondary detection channel 112 performs detection by using the TE-mode polarized light in the reflected light beam. Compared with the solution in the related art that only the TM-mode polarized light in the reflected light beam is used to perform detection, more detection data and a stronger detection signal can be obtained, thereby improving the measurement precision. Meanwhile, the situation that the object cannot be detected due to the fact that the TM-mode polarized light in the reflected light beam of the object is weak and the TE-mode polarized light in the reflected light beam is high is avoided. The intensity ratio of the TE-mode polarized light in the reflected light beam to the TM-mode polarized light can be obtained by comparing the intensities of the energy detected by the two detection channels, so as to determine the reflection characteristic and the surface topography of the object.

In some embodiments, as shown in FIG. 2, the primary transmission-detection channel 111 has a polarization rotator 1112 configured to convert the received TM-mode polarized light into TE-mode polarized light. Since the light transmitted on the LiDAR chip is usually TE-mode polarized light, for example, the detection beam, the local oscillation beam and the local oscillation sub-beam transmitted on the LiDAR chip are TM-mode polarized light, the TM-mode polarized light received by the primary transmission-detection channel 111 for detecting the reflected light beam needs to be changed into TE-mode polarized light through the polarization rotator 1112, which is beneficial to the propagation of the polarized light in the LiDAR chip and mixing with the local oscillation sub-beam which is also the TE-mode polarized light.

The light receiving end of the secondary detection channel 112 receives TE-mode polarized light in the reflected light beam for detection, which can be directly propagated in the LiDAR chip and mixed with the local oscillation sub-beam which is also the TE-mode polarized light. The secondary detection channel 112 does not need to be provided with a polarization rotator.

In some embodiments, the LiDAR system further includes a processor, and the processor determines a determination result of the obstacle based on the first beat frequency and the second beat frequency.

In some embodiments, as shown in FIG. 1, the LiDAR system further includes a lens assembly 300 and a beam-scanning guide apparatus 400, the lens assembly 300 may be a lens or a lens group, and has focusing and collimation functions. The lens assembly 300 is configured to collimate and deflect a detection light beam emitted by the light emitting/receiving end 1111, and perform focusing on the reflected light beam to be coupled into a light transmitting/receiving end of the primary transmission-detection channel or a light receiving end of the secondary detection channel.

The beam-scanning guide apparatus 400 is disposed on a side of the lens assembly 300 close to the obstacle, and is configured to adjust an emission direction of a detection beam emitted from the light emitting/receiving end over time to implement beam scanning. The beam-scanning guide apparatus 400, for example, is an optical phased array (OPA), which can direct the direction of the beam by dynamically controlling the optical characteristics of the surface on a microscopic scale. In other embodiments, the beam-scanning guide apparatus may further include a grating, a mirror galvanometer, a polygon mirror, a MEMS mirror, or a combination of an optical phased array (OPA) and the above-described device.

In some embodiments, as shown in FIG. 1, the lens assembly 300 is, for example, a convex lens, the detection light beam is TE-mode polarized light, the polarization direction of the detection light beam is shown in FIG. 1, and is parallel to the paper surface, and is indicated as a vertical solid line with arrows at both ends. The reflected light beam includes TE-mode polarized light and TM-mode polarized light, the polarization direction of the TM-mode polarized light in the reflected light beam is perpendicular to the paper surface, and is shown in FIG. 1 by using a hollow circle. The polarization direction of the TE-mode polarized light in the reflected light beam is shown in FIG. 1 and is parallel to the paper surface, and is indicated by using vertical dotted lines with arrows at both ends. The lens assembly 300 is disposed between the LiDAR chip 100 and the beam-scanning guide apparatus 400.

In some embodiments, as shown in FIG. 1, the LiDAR system 1000 further includes a polarization transmission beam-splitting apparatus 500, the polarization transmission beam-splitting apparatus 500 is disposed between the LiDAR chip 100 and the lens assembly 300, and the polarization transmission beam-splitting apparatus 500 is configured to allow the TM-mode polarized light in the reflected light beam to pass in an original direction, so that TM-mode polarized light in the reflected light beam is incident to the light emitting/receiving end 1111; and to allow the TE-mode polarized light in the reflected light beam to be translated and biased so that the TE-mode polarized light in the reflected light beam to be incident to the light receiving end 1121

In some embodiments, as shown in FIG. 1, the polarization transmission beam-splitting apparatus 500 includes a Faraday rotator 510, a half-wave plate 520, and a polarization beam bias device 530 that are sequentially disposed in a direction away from the LiDAR chip 100.

For any laser transmission-detection channel 110, the light emitting/receiving end 1111 of the primary transmission-detection channel 111 emits a detection light beam in a direction parallel to the optical axis of the lens assembly 300, and the detection light beam sequentially passes through the Faraday rotator 510, the half-wave plate 520, the polarization beam bias device 530, the lens assembly 300, and the beam-scanning guide device 400 to reach the obstacle to form a corresponding reflected light beam.

Specifically, the detection light beam emitted by the light emitting/receiving end 1111 is a TE-mode polarized light beam, the detection light beam sequentially passes through the Faraday rotator 510 and the half-wave plate 520 and is converted into TM-mode polarized light from the TE-mode polarized light, specifically, the Faraday rotator 510 performs 45-degree rotation in the polarization direction of the detection light beam, and the half-wave plate 520 also performs 45-degree rotation on the polarization direction of the detection light beam. After the TM-mode polarized light serving as the detection light beam passes through the polarization beam bias device 530 in the original direction, the TM-mode polarized light sequentially passes through the lens assembly 300 and the beam-scanning guide device to reach the obstacle to form the reflected light beam. The detection light beam passes through the polarization beam bias device 5300 in the original direction and is still transmitted in the direction parallel to the optical axis of the lens assembly 300. The lens assembly 300 collimates the detection light beam and deflects it towards the optical axis of the lens assembly 300. The detection light beam has a certain divergence angle, and after passing through the lens assembly 300, the detection light beam is collimated into a parallel light beam, and is deflected towards the optical axis of the lens assembly 300. The beam-scanning guide apparatus 400 adjusts the emission direction of the detection light beam over time to implement beam scanning.

After the TM-mode polarized light serving as the detection light beam encounters an obstacle to form a corresponding reflected light beam, the reflected light beam does not have a specific polarization characteristic, for example, is natural light, and it may be considered that the reflected light beam includes TE-mode polarized light and TM-mode polarized light. The TM-mode polarized light in the reflected light beam passes through the half-wave plate 520 and the Faraday rotator 510 in sequence after the reflected light beam passes through the polarization beam bias device 530 in the original direction, then the TM-mode polarized light enters the light emitting/receiving end 1111. The TE-mode polarized light in the reflected light beam passes through the half-wave plate 520 and the Faraday rotator 510 in sequence after being translated and biased by the polarization beam bias device 530, and then is incident to the light receiving end 1121. The TM-mode polarized light in the reflected light beam passing through the polarization beam bias device 530 passes through the half-wave plate 520 and the Faraday rotator 510 in sequence with the polarization state and the transmission direction unchanged. Specifically, the half-wave plate 520 performs 45° rotation on the polarization direction of the TM-mode polarized light in the reflected light beam, and the Faraday rotator 510 performs −45° rotation on the polarization direction of the TM-mode polarized light in the reflected light beam. The TE-mode polarized light in the reflected light beam passing through the polarization beam bias device 530 sequentially passes through the half-wave plate 520 and the Faraday rotator 510 with the polarization state and the transmission direction unchanged. Specifically, the half-wave plate 520 performs 45° rotation on the polarization direction of the TE-mode polarized light in the reflected light beam, and the Faraday rotator 510 performs −45° rotation in the polarization direction of the TE-mode polarized light in the reflected light beam.

In some embodiments, a distance between the light emitting/receiving end 1111 and the light receiving end 1121 is substantially equal to a bias distance d performed by the polarization beam bias device 530 to the TE-mode polarized light in the reflected light beam, and the bias distance d satisfies the following formula:

$$tan ( α ) = ( 1 - \frac{{n}_{o}^{2}}{{n}_{e}^{2}} ) \cdot \frac{tan ( θ )}{1 + \frac{{n}_{o}^{2}}{{n}_{e}^{2}} \cdot {tan}^{2} ( θ )}$$

$$d = L \times tan ( α )$$

where L is the thickness of the polarization beam bias device, α is the bias angle of the polarization beam bias device to the TE-mode polarized light, θ is the angle between the optical axis of the polarization beam bias device and the wave vector, nₒ is the refractive index of the TM-mode polarized light in the polarization beam bias device, and nₑ is the refractive index of the TE-mode polarized light in the polarization beam bias device. As shown in FIG. 1, the wave vector is, for example, a horizontal direction, and an optical axis of the polarization beam bias device is marked by a dashed line.

In some embodiments, as shown in FIG. 1, the LiDAR system 1000 further includes a laser source 200, and the laser source 200 is docked with the LiDAR chip 100 and is configured to generate a laser. At least a portion of the laser is used as a detection beam to perform detection, such as detecting the distance and/or velocity of the obstacle. The laser source 200 may be directly modulated by a chirp signal. That is, the driving signal for controlling the laser source 200 may be input to the laser source 200 with a time varying intensity, so that the laser source 200 generates and outputs a frequency-sweeping light beam, that is, a light beam whose frequency varies within a predetermined range. In some embodiments, the laser source 200 may further include a modulator that receives the modulation signal, and the modulator may be configured to modulate the light beam based on the modulation signal, so that the laser source 200 generates and outputs a frequency-sweeping beam, that is, a light beam whose frequency changes in a predetermined range. The frequency of the laser beam output by the laser source 200 when the laser source 200 is not modulated is substantially constant, referred to as the frequency of the unmodulated light beam, for example, 100-300 THz, the laser source 200 may output the frequency-sweeping light beam after modulation, and the frequency range of the frequency-sweeping light beam is related to the frequency of the unmodulated light beam. The laser source 200 is, for example, an external light source, light from the external light source is introduced into the LiDAR chip 100 through an optical path (for example, an optical fiber).

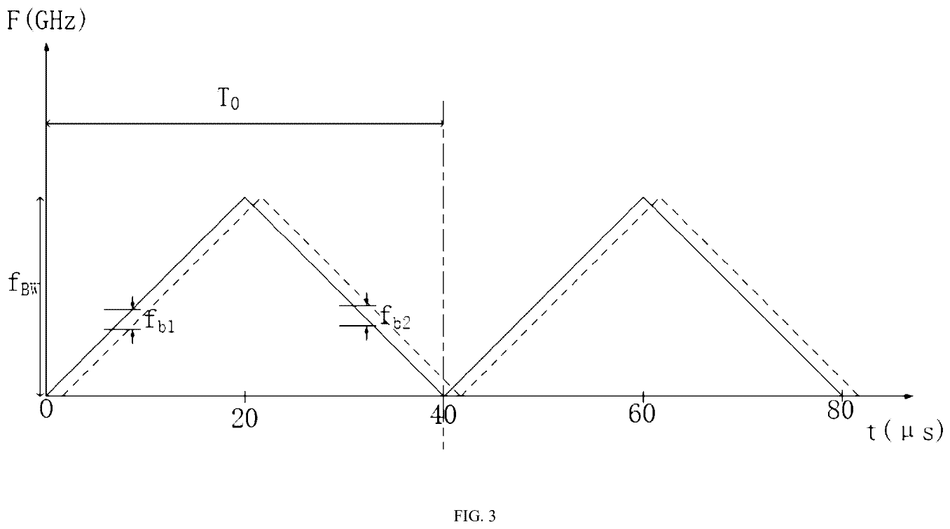

FIG. 3 is a waveform diagram of an emitted light beam and a received light beam in an FWCW frequency-sweeping manner according to the present disclosure. As shown in FIG. 3, the swept optical signal of the emitted light beam emitted by the multi-channel LiDAR system is represented by a solid line, the solid line reflects the curve of the frequency of the emitted light beam changing over time, the swept optical signal is, for example, a periodic triangular wave signal, the reflected optical signal of the reflected light beam received by the LiDAR system is represented by a dashed line, the dashed line shows the curve of the frequency of the received reflected light beam changing over time, the reflected optical signal is also, for example, a periodic triangular wave signal, and there is a delay between the reflected optical signal and the frequency-sweeping optical signal.

Only two frequency-sweeping measurement periods are shown in FIG. 3. In each frequency-sweeping measurement period, the frequency-sweeping optical signal includes one frequency-ascending phase and one frequency-descending phase, and correspondingly, the corresponding reflected optical signal also includes one frequency-ascending phase and one frequency-descending phase.

As shown in FIG. 3, the horizontal coordinate represents time, the unit is μs, the vertical coordinate represents frequency, the unit is GHz, the frequency of the emitted light beam is increased from 0 to 4 GHz, for example, and then is decreased from 4 GHz to 0, and repeats in this way. Accordingly, the frequency of the received reflected light beam is increased from 0 to 4 GHz, for example, as the time increases, and then the frequency is reduced from 4 GHz to 0, and changes periodically in this way.

For any measurement point, the distance R of the obstacle is determined by the following formula:

$$R = \frac{{C}_{0}}{8} \frac{{T}_{0}}{{f}_{BW}} ( {f}_{b 1} + {f}_{b 2} )$$

where T₀ is a preset frequency-sweeping measurement period, f_{BW} is the preset frequency-sweeping bandwidth, f_{b1} is a beat frequency in a frequency-ascending stage, f_{b2} is a beat frequency in a frequency-descending stage, and C₀ is a speed of light.

The speed v of the obstacle satisfies the following relationship:

$$v = - \frac{{C}_{0}}{4} \frac{1}{{f}_{0}} ( {f}_{b 1} - {f}_{b 2} )$$

where C₀ is the speed of light, f_{b1} is the beat frequency of the frequency-ascending stage, f_{b2} is the beat frequency in the frequency-descending stage, and f₀ is the frequency of the unmodulated light beam.

In this specification, each part is described in a parallel and progressive manner, each part focuses on a difference from other parts, and the same or similar parts among the parts may be obtained by referring to each other.

With regard to the above description of the disclosed embodiments, the features described in the embodiments of the present disclosure may be replaced or combined with each other, so that those skilled in the art can implement or use the present disclosure. Various modifications to these embodiments will be apparent to those skilled in the art, and the general principles defined herein may be implemented in other embodiments without departing from the spirit or scope of the present disclosure. Thus, the present disclosure will not be limited to the embodiments shown herein but is to be accorded the widest scope consistent with the principles and novel features disclosed herein.

Finally, it should be noted that the embodiments in this specification are described by way of example, each embodiment focuses on differences from other embodiments, and the same or similar parts between the embodiments refer to each other. For the system or device disclosed in the embodiment, since it corresponds to the method disclosed in the embodiments, the description is relatively simple, and for the relevant parts, reference may be made to the description of the method part.

Although the present disclosure has been described in detail with reference to the foregoing embodiments, a person of ordinary skill in the art should understand that the technical solutions described in the foregoing embodiments may still be modified, or some of the technical features may still be equivalently replaced; and these modifications or replacements do not make the essence of the corresponding technical solutions depart from the spirit and scope of the technical solutions of the embodiments of the present disclosure.

What is claimed is:

1. A Light Detection And Ranging (LiDAR) system, comprising:
a LiDAR chip, comprising at least one laser transmission-detection channel, wherein each of the at least one laser transmission-detection channel comprises:
a primary transmission-detection channel configured to transmit a detection light beam, wherein the primary transmission-detection channel has a light transmitting/receiving end, the light transmitting/receiving end is configured to emit a detection light beam, the detection light beam is reflected to generate a reflected light beam after encountering an obstacle, and the light transmitting/receiving end is further configured to receive a first part of the reflected light beam; and
a secondary detection channel, wherein the secondary detection channel has a light receiving end, and the light receiving end is configured to receive a second part of the reflected light beam, wherein the LiDAR system measures a distance and/or a speed of the obstacle according to the first part and the second part of the reflected light beam.

2. The LiDAR system according to claim 1, wherein the LiDAR chip further comprises:
a receiving port configured to receive a laser; and
an optical splitter configured to split the laser into a detection laser and a local oscillation laser, wherein the detection laser and the local oscillation laser are configured to be transmitted to the laser transmission-detection channel.

3. The LiDAR system according to claim 2, wherein
the primary transmission-detection channel comprises:
a first mixer configured to receive at least a part of the local oscillation laser and a first part of the reflected light beam, and perform a frequency-mixing operation on at least the part of the local oscillation laser and the first part of the reflected light beam to obtain a first mixed beam; and
a first detector configured to receive the first mixed beam and detect a first beat frequency between at least the part of the local oscillation laser and the first part of the reflected light beam;
the secondary detection channel comprises:
a second mixer configured to receive at least a part of the local oscillation laser and a second part of the reflected light beam, and perform a frequency-mixing operation on at least the part of the local oscillation laser and the second part of the reflected light beam to obtain a second mixed beam; and
a second detector configured to receive the second mixed beam and detect a second beat frequency between at least the part of the local oscillation laser and the second part of the reflected light beam.

4. The LiDAR system according to claim 3, wherein the LiDAR system further comprises:
a processor, configured to determine a measurement result of the obstacle based on the first beat frequency and the second beat frequency.

5. The LiDAR system according to claim 1, wherein the LiDAR system further comprises:
a lens assembly configured to collimate and deflect the detection light beam emitted by the light emitting/receiving end, and perform focusing on the reflected light beam to be coupled into the light transmitting/receiving end or the light receiving end; and
a beam-scanning guide apparatus, on a side of the lens assembly close to the obstacle and configured to adjust an emission direction of the detection light beam emitted from the light emitting/receiving end over time to implement beam scanning.

6. The LiDAR system according to claim 5, wherein the detection light beam is TE-mode polarized light, the reflected light beam comprises TE-mode polarized light and TM-mode polarized light, and the LiDAR system further comprises:
a polarization beam-splitting apparatus arranged between the LiDAR chip and the lens assembly, wherein the polarization beam-splitting apparatus is configured to allow the TM-mode polarized light in the reflected light beam to pass in an original direction so that the TM-mode polarized light in the reflected light beam is incident to the light transmitting/receiving end; and is configured to translate and bias the TE-mode polarized light in the reflected light beam so that the TE-mode polarized light in the reflected light beam to be incident to the light receiving end.

7. The LiDAR system according to claim 6, wherein the polarization beam-splitting apparatus comprises a Faraday rotator, a half-wave plate and a polarization beam bias device sequentially arranged away from the LiDAR chip,
the detection light beam sequentially passes through the Faraday rotator and the half-wave plate and then is converted into the TM-mode polarized light from the TE-mode polarized light, the TM-mode polarized light passes through the lens assembly and the beam-scanning guide apparatus after passing through the polarization beam bias device in an original direction, and reaches the obstacle to generate the reflected light beam, the reflected light beam is returned to the polarization beam bias device along the original light path, the TM-mode polarized light in the reflected light beam passes through the half-wave plate and the Faraday rotator in sequence after passing through the polarization beam bias device with the original direction unchanged, and then is incident onto the light transmitting/receiving end; the TE-mode polarized light in the reflected light beam passes through the half-wave plate and the Faraday rotator in sequence after being translated and biased by the polarization beam bias device, and then is incident to the light receiving end.

8. The LiDAR system according to claim 7, wherein a distance between the light emitting/receiving end and the light receiving end is substantially equal to a bias distance d of the polarization beam bias device to the TE-mode polarized light in the reflected light beam, and the bias distance d satisfies the following formula:
$$tan ( α ) = ( 1 - \frac{{n}_{o}^{2}}{{n}_{e}^{2}} ) \cdot \frac{tan ( θ )}{1 + \frac{{n}_{o}^{2}}{{n}_{e}^{2}} \cdot {tan}^{2} ( θ )}$$
$$d = L \times tan ( α )$$
wherein L is a thickness of the polarization beam bias device, α is a bias angle of the polarization beam bias device to the TE-mode polarized light, θ is an angle between an optical axis of the polarization beam bias device and a wave vector, nₒ is a refractive index of the TM-mode polarized light in the polarization beam bias device, and nₑ is a refractive index of the TE-mode polarized light in the polarization beam bias device.

9. The LiDAR system according to claim 6, wherein the primary transmission-detection channel has a polarization rotator configured to convert the received TM-mode polarized light into TE-mode polarized light.

10. The LiDAR system according to claim 6, wherein the LiDAR system further comprises:
a laser source docked with the LiDAR chip and configured to generate a laser.
